(19) United States
(12) Patent Application Publication
(10) Pub. No.: US 2010/0308778 A1
(43) Pub. Date: Dec. 9, 2010

(54) ELECTRONIC SYSTEM, ELECTRONIC DEVICE AND POWER SUPPLY DEVICE

(76) Inventors: Kazuo Yamazaki, Kanagawa (JP); Yukihiro Terada, Kanagawa (JP); Kouji Murakami, Fukuoka (JP); Tamiji Nagai, Kawasaki-shi (JP); Toshio Nagai, Tokyo (JP)

Correspondence Address: HOLTZ, HOLTZ, GOODMAN & CHICK PC, 220 Fifth Avenue, 16TH Floor, NEW YORK, NY, 10001-7708, US

(21) Appl. No.: 12/439,353

(22) PCT Filed: Aug. 28, 2007
(86) PCT No.: PCT/JP2007/066586

§ 371 Date: Aug. 12, 2010

(30) Foreign Application Priority Data
Aug. 30, 2006 (JP) 2006-233650

(51) Int. Cl. G05F 1/10

(52) U.S. Cl. 323/234

(57) ABSTRACT

Provided is an electronic system wherein power is accurately supplied even with a power delivery line resistance and a connector contact resistance, and furthermore, a plurality of electronic devices having requiring different power supply voltages can be handled with one power supply device. The electronic system is provided with an electronic device (50), and a power supply device (10) which is arranged to be connected/removed to and from the electronic device (50) and supplies power through a cable when connected. The electronic device (50) is provided with a first detection circuit (51) for performing detection relating to the supply amount of the power supply and outputting a first detection signal, and a control signal terminal.

### TECHNICAL FIELD

The present invention relates to a power supply device which performs power delivery through a cable, an electronic device which receives the power delivery to perform a functional operation, and an electronic system in which the electronic device and the power supply device are combined.

### BACKGROUND ART

Conventionally there is an electronic device which receives power delivery from a power supply device such as an AC adapter to perform a functional operation. In the general AC adapter, an output voltage and an output current are internally detected to control a power delivery output amount.

In cases where the power delivery is performed through the cable, a supply voltage is slightly lowered by a wiring resistance of the cable and a contact resistance of a connector. Therefore, in the electronic device in which a relatively correct power supply voltage is required, usually an output voltage of the AC adapter is set at a value which is slightly higher than the necessary voltage, and the correct and stable internal power is supplied to the internal circuit by lowering an input power with a regulator circuit or the like in the electronic device.

For example, in a system such as a portable telephone in which a secondary battery such as a lithium-ion battery is charged by the power from the AC adapter, the above-described voltage control is generally performed in the portable telephone because the correct voltage is required for the charge in a constant voltage mode.

In the conventional technique relating to the present invention, for example, Japanese Patent Publication Laid-Open No. 2002-315217 discloses a power supply device which can switch various output voltages to perform the power delivery by interposing an adapter for setting the output voltage.

### DISCLOSURE OF THE INVENTION

The Problems to be solved by the Invention

When the correct voltage can be supplied to the internal circuit from the AC adapter even if the wiring resistance of the cable and the contact resistance of the connector exist, advantageously the need to internally provide the regulator circuit or the like to perform the voltage control is eliminated even if the correct power supply voltage is required.

Sometimes a need to thin a power delivery line to enhance flexibility of the cable or a need to miniaturize the connector arises in the power supply device such as the AC adapter. When the need is satisfied, the wiring resistance of the cable and the contact resistance of the connector are increased to hardly perform the correct voltage supply.

An object of the invention is to provide a power supply device and an electronic device which can correctly perform the power delivery even if the resistance of the power delivery line or the contact resistance of the connector exists.

Another object of the invention is to provide a power supply device and an electronic device which can perform the power delivery suitable to a plurality of electronic devices having different necessary voltages and currents by one power supply device.

Means for solving the Problems

In order to achieve the object of the invention, there is provided an electronic system, which comprises:

an electronic device (50, FIG. 1); and

a power supply device (10) to be detachably connected to the electronic device, for performing power delivery to the electronic device through a cable when being connected to the electronic device,

wherein an output control signal is transmitted from the electronic device (50) to the power supply device (10), and the power supply device performs a power supply output control based on the output control signal.

Concretely, it is preferable to provide the electronic device (50), which includes:

a first detecting circuit (51) for performing a detection (detection of power supply voltage or power supply current) relating to power supply amount to output a first detection signal; and

a control signal terminal for transmitting the first detection signal to the power supply device when being connected to the power supply device, and

the power supply device includes:

a power supply circuit (11) an output of which is variable; and

a control circuit (12) for performing an output control of the power supply device based on the first detection signal.

According to this system, since detection of power supply voltage or power supply current is internally detected in an electronic device, and a power supply output control is performed based on the detection, it is possible to perform power delivery with a correct value even if a wiring resistance of the cable and a contact resistance of a connector exist. Accordingly, it is not necessary to generate stable internal power by providing a regulator circuit or the like in an internal circuit of the electronic device even if the electronic device needs a correct power supply voltage.

More concretely, it is preferable that the first detection signal is an analog signal, and the first detecting circuit (51) changes the first detection signal from a reference value by a predetermined amount according to a detected value, and

the control circuit (12) performs a control operation so as to increase the power supply output when the first detection signal is the reference value, and reduce the power supply output according to the changed amount when the detection signal is changed from the reference value by the predetermined amount.

According to this system, it is possible to configure the power supply device of structures almost similar to a conventional power supply circuit for a power supply output. Also, a detection signal is a signal to be serially changed from a reference value. Accordingly, even if detection such as detection of power supply voltage or detection of power supply current is performed in the electronic device, it is possible to realize to perform output control based on two kinds of detections by summing each detection signal and outputting it on the side of the power supply device. That is, it is possible to control so as to keep a predetermined power supply current according to a current detection when a load resistance is low, and keep a predetermined power supply voltage according to a voltage detection when a load resistance increases and the power supply voltage increases.

Further, the power delivery suitable to a plurality of kinds of electronic devices each having different necessary power supply voltage and current can effectively be performed by one power supply device. For example, in some electronic device, it is possible to supply power supply voltage (4V) to the electronic device by outputting a detection signal to change the detection signal from a reference value near the power supply voltage (4V). In another electronic device, it is possible to supply power supply voltage (6V) to the electronic device by outputting a detection signal to change the detection signal from a reference value near the power supply voltage (6V).

It is preferable that the power supply device (10A, FIG. 3) includes a second detecting circuit (14) for detecting the output voltage and/or the output current to output a second detection signal, and

the control circuit (12) performs the output control based on the second detection signal (S2) when the first detection signal (S1) is not inputted.

According to these structures, it is possible to prevent inconvenience that an output voltage abnormally increases by the lack of stability of output control of the power supply device because of no input of the detection signal when a connection between the power supply device and the electronic device is disconnected.

Concretely, it is preferable that the control circuit (12) performs a control operation so as to increase the power supply output when the first detection signal and second detection signal are the reference value, and reduce the power supply output according to the changed amount when the first detection signal or the second detection signal is changed from the reference value by the predetermined amount,

the first detecting circuit or the second detecting circuit changes the first detection signal or the second detection signal from the reference value when the detected voltage exceeds each of setting voltages, and

the setting voltage of the second detecting circuit is larger than the setting voltage of the first detecting circuit.

Further, it is preferable that the first detecting circuit or the second detecting circuit change the first detection signal or the second detection signal from the reference value when the detected current exceeds each of setting currents, and

the setting current of the second detecting circuit is larger than the setting current of the first detecting circuit.

Furthermore, it is preferable that the power supply device includes an adder circuit (15) for adding the first detection signal and the second detection signal, and

the output control is performed by transmitting an output of the adder circuit to the control circuit.

According to these structures, it is possible to properly automatically performing the switching of the detection signal at the time of connection and disconnection between the power supply device and the electronic device. That is, in the structures of the first detecting circuit and the second detecting circuit, the output control is performed so as to reduce power supply output by largely changing the detection signal in first according to a small one of setting voltage or setting current each being a reference value for detection. Accordingly, when the power supply device and the electronic device are connected, the output control is performed according to the detection signal on the side of the electronic device in which the setting voltage or setting current is set in a small value, and the output control is performed according to the detection signal of the power supply device when the connection between the power supply device and the electronic device is disconnected and the detection signal on the side of the electronic device is not inputted.

It is more preferable that the electronic device (50B) includes:

a third detecting circuit (53) for performing a detection relating to the power supply amount; and

a first switching circuit (54) for selectively switching an output of the first detecting circuit (51a) or the third detecting circuit (53) to output it on a side of the power supply device, and

the power supply device (10B) includes:

a second detecting circuit (14a) for performing a detection relating to the power supply amount to output a detection signal;

a second switching circuit (16) for selectively switching a detection signal of the electronic device or the detection signal of the second detecting circuit (14a) to output the detection signal to the control circuit (12); and

a signal detecting circuit (17) for detecting presence or absence of the detection signal from the electronic device to perform the switching of the second switching circuit (16), wherein

the first detecting circuit, the second detecting circuit or the third detecting circuit change an output value from the reference value when the detected value exceeds each of setting values, and

the setting value (V1) of the first detection circuit is larger than the setting value (V2) of the second detecting circuit, and the setting value (V2) of the second detecting circuit is larger than the setting value (V3) of the third detecting circuit.

Also, concretely, it is preferable that the first switching circuit (54) switches a connection on the side of the third detecting circuit when there is no output from the third detecting circuit, and switches a connection on a side of the first detecting circuit after a predetermined delay time passes when the output of the third detecting circuit is generated, and

the second switching circuit (16) switches a connection on a side of the detection signal of the electronic device when the signal detection circuit (17) detects presence of the detection signal, and switches a connection on the side of the second detecting circuit when the signal detecting circuit (17) detects absence of the detection signal.

According to these structures, it is possible to properly automatically performing the switching of the detection signal at the time of connection and disconnection between the power supply device and the electronic device. Further, since the setting value of the second detecting circuit is lower than the setting value of the first detecting circuit, it is possible to set the output voltage low at the time of disconnection in comparison with the supply voltage at the time of connection. Accordingly, it is possible to prevent breaking or the like of the circuit when a connector of the power supply device is connected to other circuits in error, or when the short of the circuit occurs.

Also, according to the electronic system of the invention, it is preferable that the electronic device (50C, FIG. 5) includes:

a plurality of voltage detecting circuits (51va to 51vc) each detecting an input power supply voltage, for respectively outputting voltage detection signals based on a plurality of setting voltages, each value of which differs each other; and

a third switching circuit (56) for selectively switching a voltage detection signal of any of the plurality of voltage detecting circuits to output the voltage detection signal to the power supply device,

wherein the power supply device (10C) includes:

a control circuit (12) for performing an output control of the power delivery;

a current detecting circuit (18) for detecting an output current to be able to output a current detection signal based on a plurality of setting currents, each value of which differs each other; and

a setting switching unit (19, 20) for switching the setting current of the current detecting circuit based on the output voltage,

wherein the output control of the control circuit (12) is performed based on the detection signal inputted from the electronic device and the detection signal of the current detecting circuit (50C).

According to this system, it is possible to perform switching control of input voltage on the side of the electronic device, and perform automatically switching of the maximum value of the output current on the side of the power supply device according to the switching. Accordingly, for example, it is possible to perform the power supply output so as not to increase a load to the circuit or the like too much by outputting large current at the time of small voltage or outputting small current at the time of large voltage.

Also, it is preferable that the electronic device (50D) includes:

a switching circuit (SW1) series-connected on a power delivery line and capable of cutting off a power supply input;

a first voltage detecting circuit (51f) for detecting a power supply voltage at a node point on an internal circuit side by the switching circuit;

a second voltage detecting circuit (51e) for detecting the power supply voltage by the switching circuit on a power supply input terminal side; and

a signal switching circuit (59) for switching the detection signal of the first voltage detecting circuit or the detection signal of the second voltage detecting circuit to a side of the power supply device.

According to this system, it is possible to cut off power delivery on the side of electronic device by turning off the switching circuit while being connected to the power supply device. Also, at this time, though an output of detection signal is stopped from the first detecting circuit by cutting off power supply input, it is possible to stabilize the output control of the power supply output control by outputting the detection signal from the second detecting circuit.

Concretely, it is preferable that the signal switching circuit (59) switches to a side of the first voltage detecting circuit when the switching circuit is on, and switches to a side of the second voltage detecting circuit when the switching circuit is off.

Also, it is possible to realize the switching of the detection signal automatically by setting “setting voltage (Vw)>setting voltage (Vn)”.

Further, it is preferable that a control circuit (12) for performing the output control of the power supply device controls to reduce the power supply voltage when the detection signal of the second voltage detecting circuit (51e) is inputted in comparison with the power supply voltage when the detection signal of the first voltage detecting circuit (51f) is inputted.

According to these structures, though it is necessary to perform the switching control of the detection signal according to the switching of the switching circuit, it is possible to set output voltage low when power supply input is cut off.

In addition, in the explanation in this title, signs corresponding to the embodiments are shown by parenthesis writing, the invention is not limited to this.

### Effects of the Invention

Thus, in the invention, the correct power delivery can effectively be performed from the power supply device to the electronic device even if the resistance of the power delivery line or the contact resistance of the connector exists.

Additionally the power delivery suitable to the plurality of electronic devices each having different necessary power supply voltage and current can effectively be performed by one power supply device.

### BRIEF DESCRIPTION OF THE DRAWINGS

FIG. 1 a block diagram showing a basic configuration of an electronic system according to a first embodiment of the invention.

FIG. 2A is a graph showing output characteristic of the detecting circuit.

FIG. 2B is a graph showing output characteristic of the detecting circuit.

FIG. 3 is a block diagram showing a configuration of an electronic system according to a second embodiment of the invention.

FIG. 4 is a block diagram showing a configuration of an electronic system according to a second embodiment of the invention.

FIG. 5 is a block diagram showing a configuration of an electronic system according to a second embodiment of the invention.

FIG. 6 is a graph showing an electric characteristic of the power supplied in the electronic system show in FIG. 5.

FIG. 7 is a flowchart explaining an example of switching operation of power control in the electronic system shown in FIG. 5.

FIG. 8 is a block diagram showing a configuration of an electronic system according to a fifth embodiment of the invention.

FIG. 9 is a graph showing an electric characteristic of output power in the electronic system shown in FIG. 8.

### EXPLANATION OF REFERENCE NUMERAL

10, 10A-10D AC adaptor

11 SW power supply circuit

12 control circuit

13 detection receiving circuit

14 detecting circuit on the side of AC adapter

14a second detecting circuit

15 adder circuit

16 second switching circuit

17 signal detecting circuit

18 current detecting circuit

19 voltage detecting circuit

20 setting switching circuit

50, 50A-50D electronic device

51 detecting circuit

51a first detecting circuit

51va-51vc detecting circuit

51e, 51f voltage detecting circuit

53 auxiliary detecting circuit

54 first switching circuit

56 third switching circuit

59 signal switching circuit

h1 power delivery line

h2 ground line

h3 detection signal line

R1-R3 wiring resistance

T0, T1 power supply terminal

T2 control signal terminal

SW1 switching circuit

### THE BEST MODE FOR CARRYING OUT THE INVENTION

Hereinafter, the embodiments of the inventions will be explained in view of drawings.

### First Embodiment

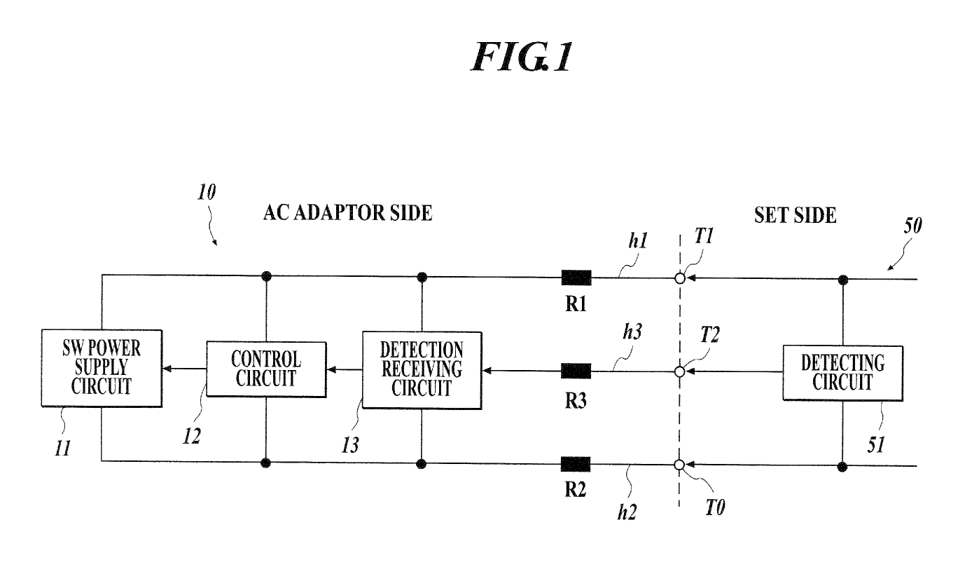

FIG. 1 is a block diagram showing a basic configuration of an electronic system according to a first embodiment of the invention.

The electronic system of the first embodiment includes a set instrument 50 as an electronic device and AC adapter 10 as a power supply device. The set instrument 50 receives the power delivery from the outside to perform the functional operation. The AC adapter 10 is detachably connected to the set instrument 50, and the AC adapter 10 performs the power delivery when being connected to the set instrument 50.

The AC adapter 10 and the set instrument 50 can be connected to each other while a connector having at least three terminals T0 to T2 is interposed therebetween. In the three terminals T0 to T2, the power supply voltage is fed into the power supply terminals T0 and T1, and the control signal terminal T2 is used to supply a power supply output control signal from the set instrument 50 to the AC adapter 10.

The AC adapter 10 includes an adaptor main body portion on which a power supply circuit is mounted and a power delivery cable extended from the adaptor main body portion. The connector having the power supply terminal T0 and T1 and the control signal terminal T2 is provided at a leading end of the cable. A power delivery line h1, a ground line h2, and a control signal line h3 are wired in the cable, and parasitic wiring resistances R1 to R3 are added to the lines h1 to h3 respectively.

As shown in FIG. 1, the AC adapter 10 includes a SW power supply circuit 11, a control circuit 12, and a detection receiving circuit 13. An alternating-current power is fed into the SW power supply circuit 11, and the SW power supply circuit 11 supplies an electric power controlled by a switching operation of a transistor. The control circuit 12 performs output control by changing a frequency or an on-interval of the switching operation of the SW power supply circuit 11. The detection receiving circuit 13 such as a receiving buffer receives an output control detection signal transmitted from the set instrument 50.

In addition to a functional circuit (not shown) which performs the functional operation as the set instrument 50, the set instrument 50 includes a detecting circuit 51 and a signal transmitting circuit (not shown). The detecting circuit 51 detects a voltage at a node point on a power supply line in which the correct power supply voltage or power supply current is required in the circuit. The signal transmitting circuit such as a voltage follower amplifies the electric power of the detection signal of the detecting circuit 51, and the signal transmitting circuit transmits the amplified detection signal to the AC adapter 10 through the control signal terminal T2.

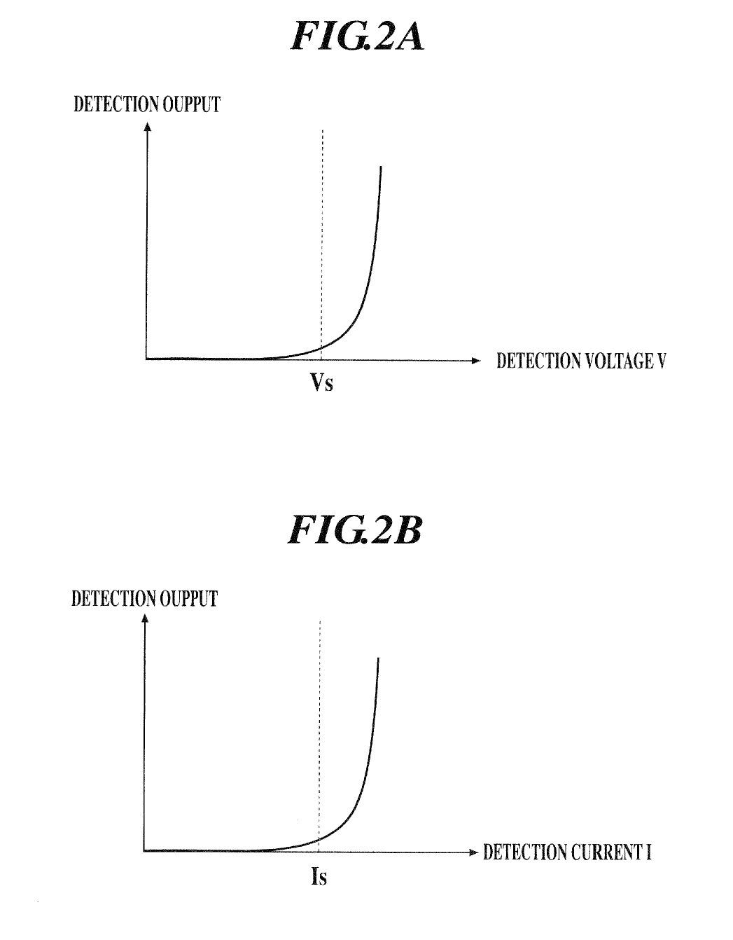

FIGS. 2A and 2B are graphs showing output characteristic of the detecting circuit.

In the detecting circuit 51, a voltage obtained by partitioning the power supply voltage with a partitioned resistor is compared to a reference voltage, and an error amplifier amplifies the voltage difference to supply the detection signal. In the operation of the error amplifier, an output voltage is set at the reference value (for example, voltage value of zero) when the partitioned voltage is smaller than the reference voltage, and the output voltage is increased when the partitioned voltage is equal to or larger than the reference voltage.

Therefore, as shown in FIG. 2A, the detection signal supplied from the detecting circuit 51 is maintained at the reference value until a detected voltage V becomes a predetermined voltage which is lower than a setting voltage Vs, the voltage value of the detection signal is raised when the detected voltage V exceeds the predetermined voltage which is lower than the setting voltage Vs, and the voltage value of the detection signal is increased when the detected voltage V exceeds the setting voltage Vs.

The setting voltage Vs can be set at any value by appropriately selecting a resistance of the partitioned resistor. In the first embodiment, the setting voltage Vs is set at the necessary power supply voltage.

Alternatively, the power supply current detecting circuit can be included in the detecting circuit 51. In a configuration of the power supply current detecting circuit, a resistor having a small resistance is provided on a path through which the detected current is passed, a converted voltage generated at both ends of the resistor is compared to the reference voltage, and the error amplifier amplifies the voltage difference to supply the detection signal. At this point, the error amplifier sets the output voltage at the reference value (for example, voltage value of zero) when the converted voltage is smaller than the reference voltage, and the error amplifier increases the output voltage when the converted voltage is equal to or larger than the reference voltage.

Therefore, as shown in FIG. 2B, the detection signal supplied from the power supply current detecting circuit is maintained at the reference value until a detected current I becomes a predetermined current which is lower than a setting current Is, the voltage value of the detection signal is raised when the detected current I exceeds the predetermined current which is lower than the setting current Is, and the voltage value of the detection signal is increased when the detected current I exceeds the setting current Is. The setting current Is can be set at any value by appropriately selecting a resistance of the current-voltage conversion resistor.

In cases where both the power supply voltage detecting circuit and the power supply current detecting circuit are included in the detecting circuit 51, the voltage values of the detection signals of the power supply voltage detecting circuit and the power supply current detecting circuit may be added and supplied as one signal. In such cases, as shown in FIGS. 2A and 2B, the detection signal is maintained at the reference value until the power supply voltage V or the power supply current I becomes the neighborhood of the setting voltage Vs or setting current Is, and the voltage of the detection signal is raised when one of the power supply voltage V and the power supply current I exceeds the neighborhood of the setting voltage Vs or setting current Is.

The control circuit 12 of the AC adapter 10 increases the output of the SW power supply circuit 11 when the fed detection signal is smaller than the predetermined voltage. When the detection signal is larger than the predetermined voltage, the control circuit 12 shortens the on-interval of a switching element of SW power supply circuit 11 or lengthens a switching frequency, in order to reduce the output of the SW power supply circuit 11.

Accordingly, the output control of the AC adapter 10 is performed by the detecting operation of the detecting circuit 51 and the control operation of the control circuit 12, thereby correctly supplying the voltage of the setting voltage Vs at the detecting point of the detecting circuit 51. When a load resistance of the set instrument 50 is lowered to increase the output current, the output current reaches the setting current Is of the detecting circuit 51. At this point, the voltage of the setting current Is is correctly supplied at the detecting point of the detecting circuit 51 by the action of the output of the power supply current detecting circuit.

In the electronic system of the first embodiment, the voltage or the current is detected on the side of the set instrument 50, and the output of the AC adapter 10 is controlled based on the detection signal of the set instrument 50. Therefore, even if the wiring resistances R1 to R3 of the cable are relatively increased in the AC adapter 10, or even if the contact resistance of the connector is relatively increased, the correct power supply voltage or power supply current can be supplied to the set instrument 50 while the influences of the increased resistances are removed. Accordingly, when the internal circuit in which the correct voltage or current is required exists, the power delivery can be performed from the AC adapter 10 to the internal circuit directly without providing the regulator circuit in the set instrument 50.

Although the wiring resistance R3 and the terminal contact resistance are generated in the control signal line h3 through which the detection signal is transmitted, the influences of the wiring resistance R3 and the terminal contact resistance can be reduced to negligible levels because the current of the detection signal is set at a value that is extremely smaller than that of the power delivery line h1.

Additionally, in the electronic system of the first embodiment, the different power supply voltages or power supply currents can be supplied to the AC adapter 10 by changing the setting voltage Vs or setting current Is of the detecting circuit 51 of the set instrument 50. Therefore, advantageously the one AC adapter 10 can suitably perform the power delivery according to the plurality of kinds of electronic devices in which different power supply voltages are required.

In the first embodiment, the output control signal transmitted from the set instrument 50 to the AC adapter 10 is not limited to the above-described detection signal, but signals having various patterns can be applied to the output control signal as long as the signal indicates a request to increase or decrease the power supply output. For example, an analog signal may be used such that the analog signal becomes a high level when the detected voltage or the detected current is lower than the setting value while becoming a low level when the detected voltage or the detected current is higher than the setting value. In such cases, the output of the control circuit 12 of the SW power supply circuit 11 is lowered when the voltage of the detection signal is low, and the output of the control circuit 12 is increased when the voltage of the detection signal is high.

### Second Embodiment

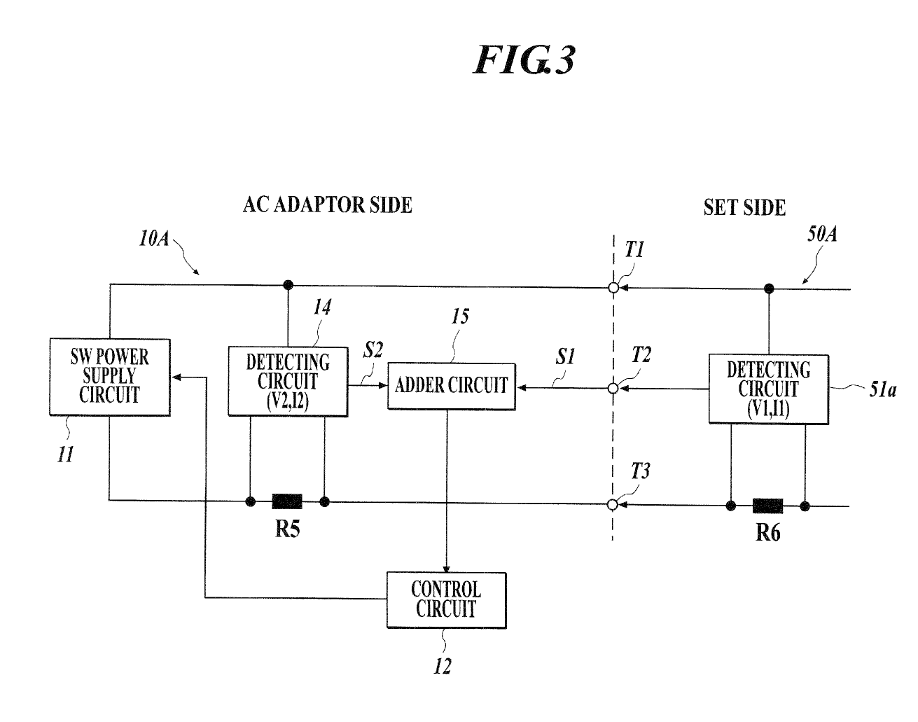

FIG. 3 is a block diagram showing a configuration of an electronic system according to a second embodiment of the invention.

In the electronic system of the second embodiment, an output voltage or output current detecting circuit 14 is also provided on the side of an AC adapter 10A in addition to the configuration of the first embodiment, and the SW power supply circuit 11 is controlled using a detection signal S2 on the side of the AC adapter 10A when a set instrument 50A and the AC adapter 10A are disconnected from each other.

Therefore, the AC adapter 10A includes the detecting circuit 14 and an adder circuit 15. The adder circuit 15 performs addition of the detection signal S2 of the detecting circuit 14 and a detection signal S1 from the set instrument 50A to supply the addition to the control circuit 12.

Similarly to the output characteristic of the detecting circuit 51 shown in FIGS. 2A and 2B, the detecting circuit 14 maintains the voltage of the detection signal S2 at the reference value (for example, voltage of zero) when the detected voltage and the detected current are lower than setting values (V2 and I2), and the detecting circuit 14 raises the voltage of the detection signal S2 when the detected voltage and the detected current exceed the neighborhoods of the setting values.

The setting voltage V2 and setting current I2 of the detecting circuit 14 are set at “V2>V1” and “I2>I1” compared with the setting voltage V1 and setting current I1 of the detecting circuit of the set instrument 50.

The adder circuit 15 is a circuit which adds the voltage values of the two analog signals to supply the addition. Specifically, a circuit which adds the voltages may be formed with an operational amplifier, or a circuit which adds the voltages may be formed only with a resistor because accuracy is not required too much for the addition.

In cases where the AC adapter 10A and the set instrument 50A are connected to each other, as the output voltage of the AC adapter 10A is increased, the output is first increased in the detection signal S1 of the detecting circuit 51a on the side of the set instrument 50A having the small setting voltage or setting current, and the output is supplied to the control circuit 12 through the adder circuit 15. The control is performed such that the output voltage is suppressed by the detection signal S1, and the output voltage is stabilized near the setting voltage V1 of the detecting circuit 51a.

At this point, because the output voltage of the AC adapter 10A is maintained at a value which is lower than the setting voltage V2 at the detecting circuit 14 on the AC adapter 10A, the detection signal S2 of the detecting circuit 14 substantially becomes zero, and the detection signal S2 has no influence on the output of the adder circuit 15. Therefore, in cases where the AC adapter 10A and the set instrument 50A are connected, the detection signal S1 on the side of the set instrument 50A is preferentially used to perform the output control.

On the other hand, in cases where the AC adapter 10A and the set instrument 50A are disconnected, because the detection signal S1 supplied from the set instrument 50A is eliminated, the output voltage of the AC adapter 10A is raised, and the output of the detecting circuit 14 on the side of the AC adapter 10A is raised when the output voltage of the AC adapter 10A becomes the neighborhood of the setting voltage V2. The detection signal S2 is supplied to the control circuit 12 through the adder circuit 15 to perform the output control. The output voltage of the AC adapter 10A is stabilized near the setting voltage V2.

In cases where the circuit having the small load resistance is connected to perform the control with the power supply current, the detection signal S1 on the side of the set instrument 50A is preferentially used to perform the output control by the same action and operation when the set instrument 50A is connected, and the detection signal S2 of the detecting circuit 14 is used to perform the output control when the set instrument 50A is not connected.

In the electronic system of the second embodiment, the detection signals S1 and S2 are appropriately switched to perform the output control according to the connection or disconnection of the set instrument 50A. Therefore, advantageously the abnormal increase or the lack of stability can be prevented in the output of the AC adapter 10A even if the set instrument 50A is disconnected to interrupt the input of the detection signal S1.

In the second embodiment, in order to switch the detection signals S1 and S2, the setting voltage or setting current values of the detecting circuits are set at an appropriate relationship, the detection signals S1 and S2 are added to supply the addition to the control circuit 12. Alternatively, a switching circuit may be provided instead of the adder circuit 15. Whether or not the detecting circuit 51a of the electronic device 50A is connected to the control signal terminal T2 is detected by impedance or the like. A signal line of the switching circuit is selectively switched such that the detection signal S1 is supplied to the control circuit 12 when the detecting circuit 51a is connected to the control signal terminal T2, and such that the detection signal S2 of the detecting circuit 14 is supplied to the control circuit 12 when the detecting circuit 51a is not connected to the control signal terminal T2. In such cases, the detecting circuit 14 on the side of the AC adapter 10A can be set at any value as described above.

### Third Embodiment

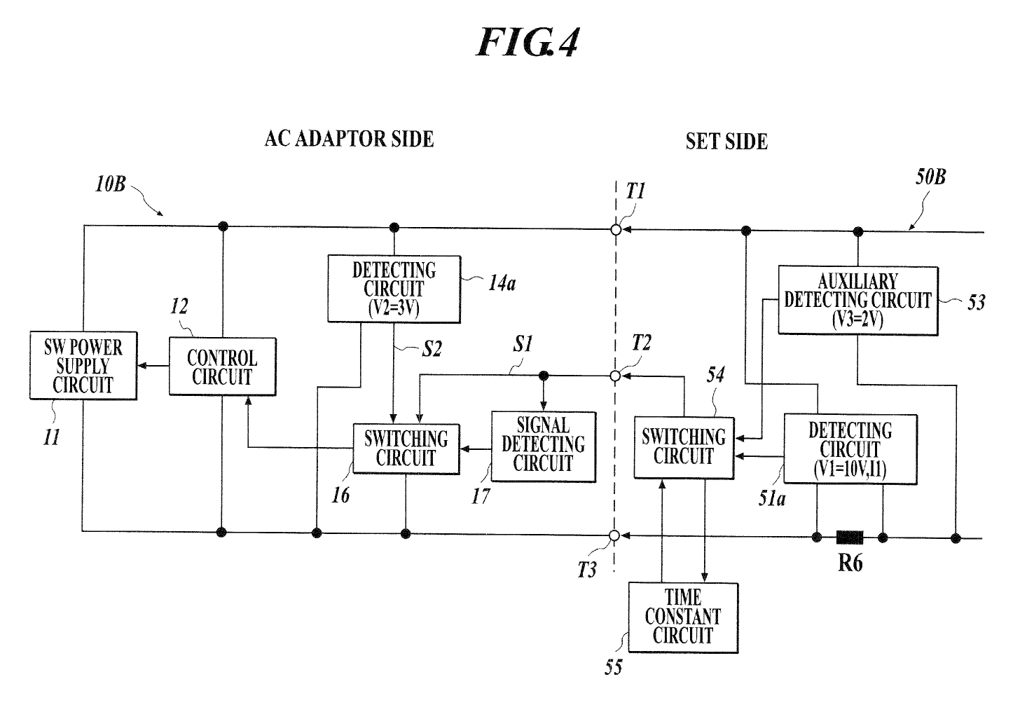

FIG. 4 is a block diagram showing a configuration of an electronic system according to a third embodiment of the invention.

In the electronic system of the third embodiment, similarly to the second embodiment, the detection signals supplied to the control circuit 12 are switched according to the connection and disconnection of a set instrument 50B. However, in the third embodiment, the output voltage in disconnecting the set instrument 50B can be set lower than the output voltage in connecting the set instrument 50B.

Therefore, the set instrument 50B of the third embodiment includes an auxiliary detecting circuit 53, a first switching circuit 54, and a time constant circuit 55 in addition to the first detecting circuit 51a which supplies the detection signal based on the setting value of the power supply voltage or power supply current (V1=10 V, and I1) necessary for the internal circuit. The auxiliary detecting circuit 53 detects the voltage at the power supply line, and the auxiliary detecting circuit 53 supplies the detection signal based on a lower setting voltage V3 (for example, 2 V). The first switching circuit 54 selectively supplies one of the detection signal of the detecting circuit 51a and the detection signal of the auxiliary detecting circuit 53. The time constant circuit 55 imparts a delay to switching timing of the first switching circuit 54.

In addition to the second detecting circuit 14a which detects the output voltage, a signal detecting circuit 17 and a second switching circuit 16 are provided in a AC adapter 10B of the third embodiment includes. The signal detecting circuit 17 detects the presence or absence of the detection signal supplied from the set instrument 50B. The second switching circuit 16 switches between the detection signal S1 on the side of the set instrument 50B and the detection signal S2 on the side of the AC adapter 10B according to the presence or absence of the detection signal. The output of the second switching circuit 16 is supplied to the control circuit 12 to perform the output control.

As described in FIGS. 2A and 2B, in the first detecting circuit 51a, the second detecting circuit 14a, and the auxiliary detecting circuit 53 are set at the setting voltage V1 to V3 respectively, the detection output is set at the reference value (for example, voltage value of zero) when the detected voltage is lower than the setting voltage, the detection output is increased when the detected voltage becomes the neighborhood of the setting voltage, and the detection output is increased according to the setting voltage when the detected voltage exceeds the setting voltage.

For example, the setting voltage V1 at the first detecting circuit 51a is set to 10 V which is necessary for the power supply voltage, and the setting voltage V2 at the second detecting circuit 14a is set to 3 V which is suitable to the standby voltage. For example, the setting voltage V3 at the auxiliary detecting circuit 53 is set to 2 V which is lower than the setting voltage V2 at the second detecting circuit 14a.

The operations of the AC adapter 10B and set instrument 50B having the configurations will be described below.

In cases where the AC adapter 10B and the set instrument 50B are not connected, because the detection signal S1 is not supplied from the side of the set instrument 50B, the signal detecting circuit 17 switches the connection of the second switching circuit 16 onto the side of the second detecting circuit 14a. Therefore, the detection signal S2 of the second detecting circuit 14a is supplied to the control circuit 12, and the output voltage is controlled to the setting voltage V2 (=3 V) at the second detecting circuit 14a.

The first switching circuit 54 is switched to the connection on the side of the auxiliary detecting circuit 53 in the reset state in which neither the power supply voltage is fed into the first switching circuit 54 of the set instrument 50B nor are supplied the detection outputs from the detecting circuits 51a and 53. At this point, when the set instrument 50B is connected, because the power supply voltage of 3 V is applied to the auxiliary detecting circuit 53, the detection output of the auxiliary detecting circuit 53 is increased, and the detection signal is supplied to AC adapter 10B through the first switching circuit 54.

On the AC adapter 10B, the signal detecting circuit 17 detects a signal input having a constant voltage or more in response to the detection signal S1 supplied from the set instrument 50B, and the second switching circuit 16 is switched onto the side of the set instrument 50B. Therefore, the detection signal S1 of the auxiliary detecting circuit 53 is fed into the control circuit 12.

At the same time, the first switching circuit 54 of the set instrument 50B operates the time constant circuit 55 based on the increased detection output of the auxiliary detecting circuit 53, and the output of the detection signal is switched onto the side of the first detecting circuit 51a in response to the signal supplied from the time constant circuit 55 after a short delay time elapses. Therefore, the output of the first detecting circuit 51a is supplied to the control circuit 12 through the first switching circuit 54 and the second switching circuit 16, whereby the output voltage is raised to the setting voltage V1 (=10 V) at the first detecting circuit 51a and stably controlled.

When the set instrument 50B is disconnected from the AC adapter 10B while the output voltage is 10 V, the output of the first detecting circuit 51a or auxiliary detecting circuit 53 is eliminated to reset the first switching circuit 54, the signal detecting circuit 17 is operated to switch the second switching circuit 16 from the connection on the side of the set instrument 50B to the connection on the side of the second detecting circuit 14a. Therefore, the output voltage is lowered to the setting voltage V2 (=3 V) at the second detecting circuit 14a.

In the AC adapter 10B and set instrument 50B of the third embodiment, the detection signals S1 and S2 are appropriately switched according to the connection or disconnection between the AC adapter 10B and set instrument 50B. Therefore, advantageously the output of the AC adapter 10B can always be stabilized, and the output voltage of the AC adapter 10B can be set lower when the AC adapter 10B and set instrument 50B are disconnected. For example, when the AC adapter 10B and set instrument 50B are disconnected, the voltage is set so as to minimize power consumption, so that the standby power of the AC adapter 10B can be set well.

### Fourth Embodiment

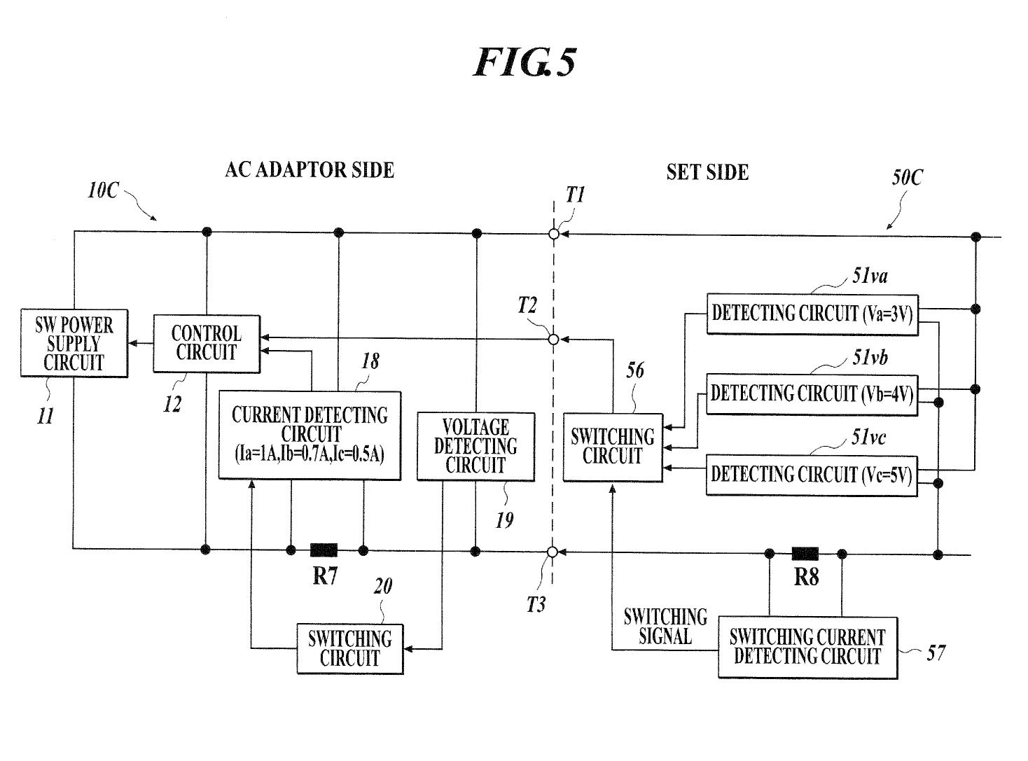

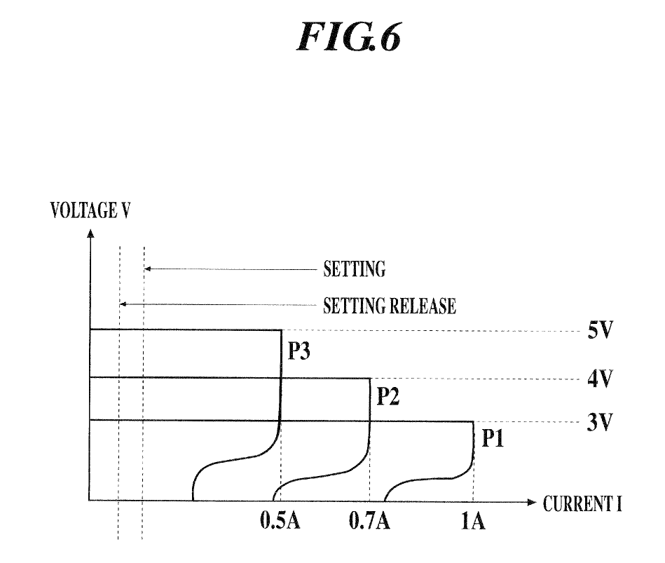

FIG. 5 is a block diagram showing a configuration of an electronic system according to a fourth embodiment of the invention. FIG. 6 is a graph showing an electric characteristic of the power supplied in the electronic system.

In the electronic system of the fourth embodiment, three voltage detecting circuits 51va to 51vc are provided on the side of a set instrument 50C, the detection signals of the voltage detecting circuits 51va to 51vc are selectively switched to perform feed back onto the side of the AC adapter 10C, and a restricted value of the output current is automatically switched on the side of the AC adapter 10C in response to the fed-back detection signal.

Therefore, the set instrument 50C of the fourth embodiment includes a third switching circuit 56 and a switching current detecting circuit 57 in addition to the three voltage detecting circuits 51va to 51vc. The third switching circuit 56 switches among the three detection signals to supply the detection signal to the control signal terminal T2. The switching current detecting circuit 57 generates the switching timing.

In the voltage detecting circuits 51va to 51vc, the setting voltages are set at different values such as “Va=3 V”, “Vb=4 V”, and “Vc=5 V”, and the detection signal is raised from the reference value (for example, voltage value of zero) when the detected power supply voltage exceeds the neighborhood of the setting voltage.

For the configuration in which the three voltage detecting circuits 51va to 51vc are switched, alternatively, the connections of the three detection signal line of the three voltage detecting circuits may be switched while the voltage detecting circuits are formed to actually supply the detection signals. Alternatively, only one voltage detecting circuit is formed to supply the detection signal, three kinds of partitioned resistors are provided to partition the detected voltage, the detected voltage is partitioned by a different partition ratio to perform the comparison with the reference voltage, and the detecting operation may be realized at the three kinds of setting voltages.

The switching current detecting circuit 57 detects the power supply current, and the switching current detecting circuit 57 supplies a switching signal when the detected current becomes a small setting release current (for example, 0.05 A) or less. In order not to cause the operation to become unstable near the setting release current, when the detected current becomes the setting release current to supply the switching signal, a hysteresis may be provided such that the next switching signal is not supplied until the detected current becomes a slightly larger setting release current (for example, 0.1 A) (see setting/setting release of FIG. 6).

The AC adapter 10C includes a current detecting circuit 18, a setting switching circuit 20, and a voltage detecting circuit 19 in addition to the SW power supply circuit 11 and the control circuit 12. The current detecting circuit 18 detects that the output current reaches the restricted current. The setting switching circuit 20 switches setting values of the restricted current of the current detecting circuit. The voltage detecting circuit 19 imparts the switching timing to the setting switching circuit 20.

The current detecting circuit 18 raises the detection signal from the reference value (for example, voltage value of zero) when the detected current exceeds the neighborhood of the setting current. In the current detecting circuit 18, the switchable setting currents are set at “Ia32 1 A”, “Ib=0.7 A”, and “Ic=0.5 A”, and the setting currents are switched according to the switching among the voltage detecting circuits 51va to 51vc.

The voltage detecting circuit 19 supplies the detected voltage indicating the analog output voltage to the setting switching circuit 20. The setting switching circuit 20 determines which three kinds of setting voltages Va to Vc at the set instrument 50C are located closest to the detected voltage, and the setting switching circuit 20 supplies the signal for switching the setting current to the corresponding one to the current detecting circuit 18.

The control circuit 12 receives the detection signal on the side of the set instrument 50C and the detection signal of the current detecting circuit 18 in the AC adapter 10C, the control circuit 12 increases the output of the SW power supply circuit 11 until one of the detection signals exceeds a predetermined value, and the control circuit 12 performs the control operation such that the output of the SW power supply circuit 11 is reduced when one of the detection signals exceeds the predetermined value.

Accordingly, when the detecting circuit 51va (setting voltage Va=3 V) is selected to set the current detecting circuit 18 at the setting current Ia=1 A, an electric characteristic is obtained as shown by a characteristic line P1 of FIG. 6. That is, a constant voltage of the setting voltage 3 V is supplied until the detected current reaches the setting current 1 A, and a constant current of the setting current 1 A is supplied when the detected current reaches the setting current 1 A.

Electric characteristics shown by characteristic lines P2 and P3, in which the constant voltages of the setting voltages and the constant currents of the setting currents are supplied, can be obtained by changing the setting voltage and the setting current to “4 V/0.7 A” and “5 V/0.5 A”.

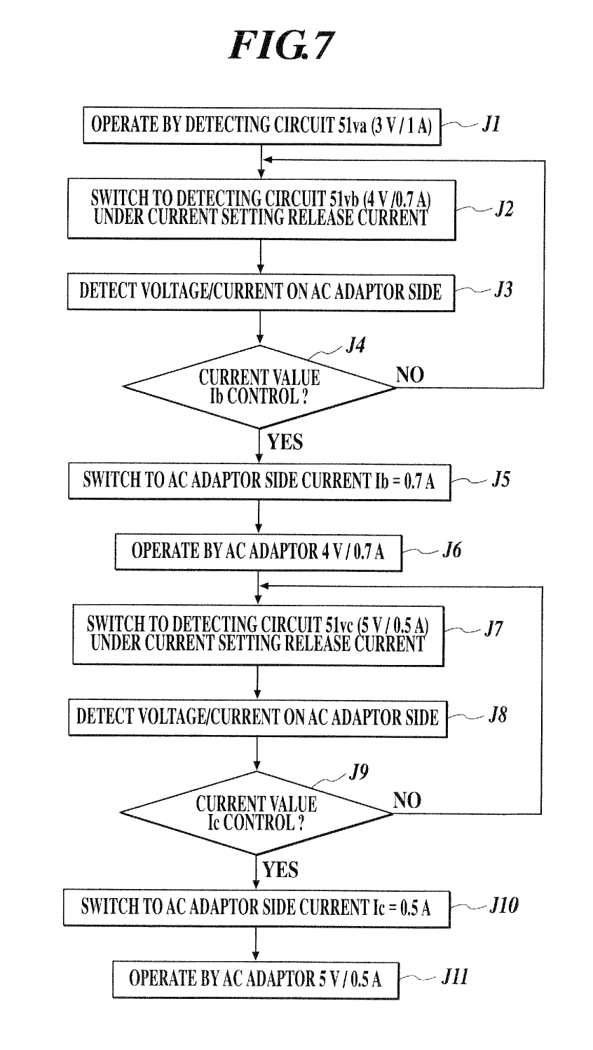

FIG. 7 is a flowchart explaining an example of switching operation of power control in the electronic system.

In the electronic system having the above-described configuration, the following switching operation is performed according to the change in output. For example, it is assumed that the detecting circuit 51va is selected to perform the constant-voltage operation with the characteristic of “3 V/1 A (setting voltage/setting current)” (Step J1). It is considered that the current is decreased as the load resistance is increased. While the current is decreased, the switching current detecting circuit 57 detects the decreased current to determine whether or not the detected current reaches the setting release current. The selections of the switching circuit 56 is switched when the detected current reaches the setting release current, and the selections of the switching circuit 56 is not switched when the detected current not reaches the setting release current (Step J2).

Meanwhile on the side of the AC adapter 10C, the voltage detecting circuit 19 and the current detecting circuit 18 detects the output voltage and the output current (Step J3), the setting switching circuit 20 determines which setting voltages Va to Vc are located closest to the output voltage. The setting currents Ia to Ic are switched according to the changed setting voltage when the setting voltage is changed, and the setting currents Ia to Ic are not switched when the setting voltage is not changed.

The operation is branched based on the determination whether or not the switching is performed (Step J4). When the switching is not performed, the operations in Steps J2 to J4 are repeated.

On the other hand, in cases where the output current is lowered to the setting release current (see FIG. 6) to perform the switching to the setting voltage Vb, because the output voltage is raised to the setting voltage Vb, the voltage detecting circuit 19 detects the setting voltage Vb, and the current detecting circuit 18 is switched to the setting current Ib based on the setting voltage Vb (Step J5).

Therefore, the output is performed with the characteristic of the setting voltage Vb and setting current Ib of “4 V/0.7 A” (Step J6).

Similarly to the operations in Steps J2 to J5, when the current is decreased as the load resistance is increased, the current detection and the switching of the setting voltage and setting current are performed in Steps J7 to J10, and therefore the power output is performed with the characteristic of the setting voltage Vc and setting current Ic of “5 V/0.5 A” (Step J11).

In the electronic system of the fourth embodiment, the switching of the restricted current can be performed on the side of the AC adapter 10C according to the switching of the setting voltage on the side of the set instrument 50C. Therefore, the maximum output can be performed while the load on the power supply circuit is restricted to a constant value. That is, the output is performed to the large current when the output voltage is low, and only the small current is supplied when the output voltage is high.

In the fourth embodiment, when the power supply current becomes small, the switching operation is performed such that the setting voltage is automatically raised. However, the setting voltages can be switched by the switching circuit 56 under various conditions. For example, the setting voltages may be switched by a microcomputer (not shown) of the set instrument 50C according to an operation mode of the set instrument 50C. In the case of a set instrument in which plurality of kinds of secondary batteries can be set, the setting voltages may be switched according to the kind of the set secondary battery. The setting voltages may be switched based on an input manipulation of a user.

### Fifth Embodiment

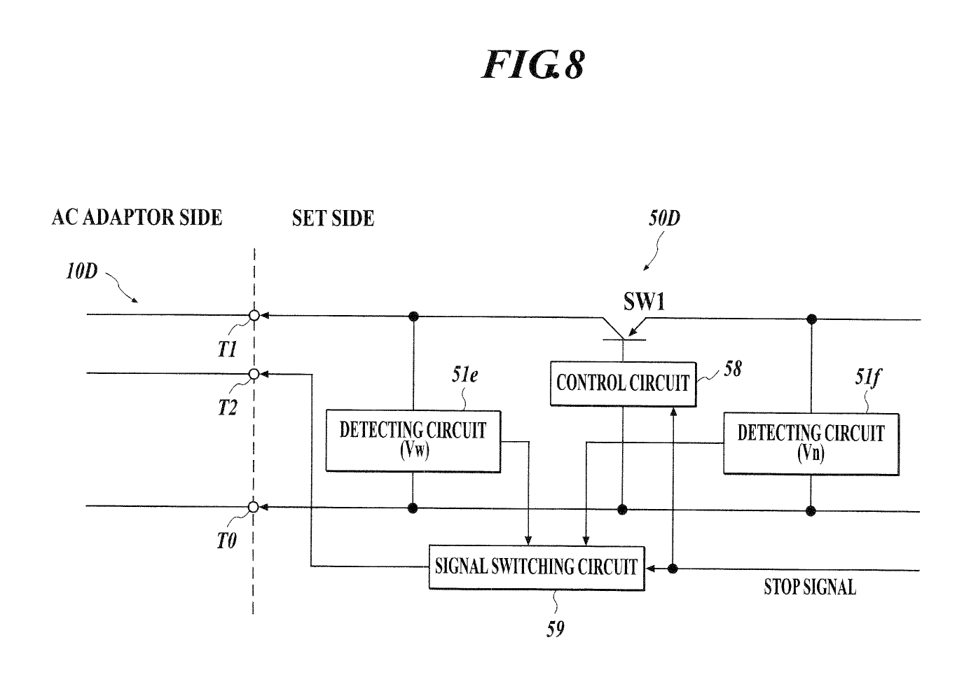

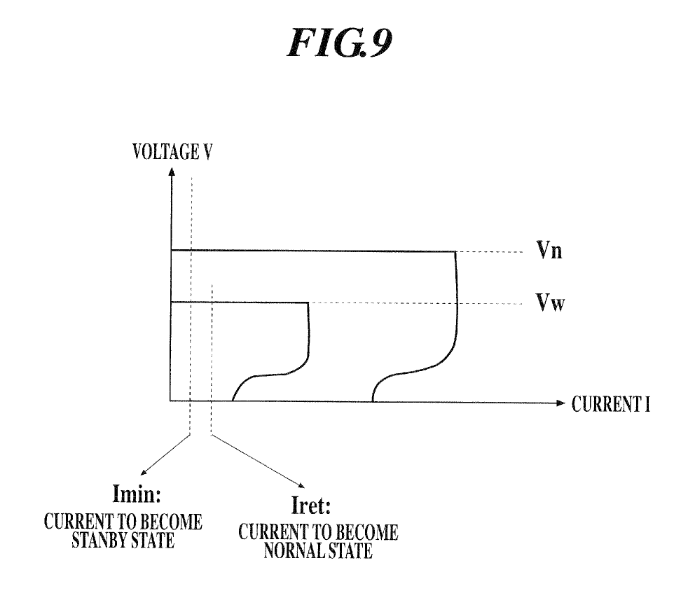

FIG. 8 is a block diagram showing a configuration of an electronic system according to a fifth embodiment of the invention. FIG. 9 is a graph showing an electric characteristic of output power in the electronic system of the fifth embodiment.

In the electronic system of the fifth embodiment, a switch circuit SW1 is provided in a set instrument 50D. The switch circuit SW1 cuts off the power supply input, when abnormality is detected, or when the internal circuit is stopped. Voltage detecting circuits 51e and 51f are provided on both sides of the switch circuit SW1 such that the outputs of the voltage detecting circuits 51e and 51f are selectively switched and supplied to the AC adapter 10D.

Therefore, the set instrument 50D of the fifth embodiment includes a control circuit 58 and a signal switching circuit 59 in addition to the switch circuit SW1 and the two voltage detecting circuits 51e and 51f. The control circuit 58 controls turn-on and turn-off of the switch circuit SW1. The signal switching circuit 59 performs the switching of the detection signal supplied onto the side of the AC adapter 10D.

The switch circuit SW1 is series-connected to the power supply line. For example, based on a stop signal supplied from the microcomputer (not shown) of the set instrument 50D or the abnormal detecting circuit, the switch circuit SW1 is turned off to cut off the power fed into the internal circuit when the abnormality is detected or when the internal circuit is stopped. In cases where the switch circuit SW1 is turned off in stopping the internal circuit, the power supply current detecting circuit may supply the stop signal when the detected power supply current is lower than an extremely small switching current Imin (see FIG. 9). At this point, in order not to cause the power supply current to become unstable near the switching current Imin, when the stop signal is supplied once, a hysteresis may be provided such that the stop signal is not released until the detected current becomes a slightly larger on-current Iret.

For example, based on the stop signal, the signal switching circuit 59 selects the detection signal of the voltage detecting circuit 51f on the internal circuit side when the switch circuit SW1 is turned on, and the signal switching circuit 59 selects the detection signal of the voltage detecting circuit 51e on the side of the power supply terminal T1 when the switch circuit SW1 is turned off. Then the signal switching circuit 59 transmits the selected detection signal to the side of the AC adapter 10D.

The two voltage detecting circuits 51e and 51f are configured such that the output is raised from the reference value when the detected voltage exceeds the neighborhood of each of setting voltages Vn and Vw. The setting voltage Vn of the voltage detecting circuit 51f is set at the power supply voltage necessary for the internal circuit, and the setting voltage Vf of the voltage detecting circuit 51e on the side of the power supply terminal T1 is set at the standby voltage in which the power consumption of the AC adapter 10D is the minimized.

In the configuration, as shown in FIG. 9, in the normal state in which the switch circuit SW1 is turned on, the detection signal of the voltage detecting circuit 51f on the internal circuit side is supplied to the side of the AC adapter 10D to perform the power delivery of the setting voltage Vn necessary for the internal circuit.

On the other hand, in the stop state in which the switch circuit SW1 is turned off, the detection signal of the voltage detecting circuit 51e on the side of the power supply terminal T1 is supplied to the side of the AC adapter 10D to perform the power delivery of the lower setting voltage Vw.

In the electronic system of the fifth embodiment, the switch circuit SW1 can cut off the power input to prevent the abnormality or the wasteful power consumption, and the detection signal supplied onto the side of the AC adapter 10D is switched when the switch circuit SW1 is turned off. Therefore, the trouble such as the abnormal increase in output of the AC adapter 10D and the unstable output of the AC adapter 10D, caused by the elimination of the feedback of the detection signal, can be avoided.

The output voltage of the AC adapter 10D is controlled to the voltage at which the power consumption becomes the minimum, when the power supply input is cut off. Therefore, advantageously the standby power can be minimized in stopping the operation of the set instrument 50D.

In the fifth embodiment, because the setting voltage Vw at the voltage detecting circuit 51e on the side of the power supply terminal T1 is set lower, the signal is supplied while switched by the signal switching circuit 59. When the setting voltage Vw is set higher than the setting voltage Vn at the voltage detecting circuit 51f, the voltages of the detection signals are added and supplied to the AC adapter 10D without providing the signal switching circuit 59. Therefore, similarly the switching control can be performed to the detection signals.

In the case of the two detection signals, the detection signal having the lower setting voltage first acts on the AC adapter 10D. Therefore, in the configuration of the setting voltages Vn and Vw of the fifth embodiment, the output is controlled by the detection signal of the voltage detecting circuit 51f having the lower setting voltage Vn when the switch circuit SW1 is turned on, and the output is controlled by the detection signal of the voltage detecting circuit 51e on the side of the power supply terminal T1 when the switch circuit SW1 is turned off.

The first to fifth embodiments of the invention are described above. However, the invention is not limited to the embodiments, but various modifications and changes can appropriately be made without departing from the scope of the invention. For example, although the AC adapter is used as power supply device in the embodiments, the power supply device is not limited to the AC-input power supply device. The characteristic configurations of the first to fifth embodiments may appropriately be combined and applied to one electronic system.

### INDUSTRIAL APPLICABILITY

The invention can be utilized to a power supply device for performing power delivery through a cable, an electronic device for perform the functional operation by receiving the power delivery, and a electronic system in which the electronic device and power supply device are combined.

1-16. (canceled)

17. An electronic system, comprising:
an electronic device; and
a power supply device to be detachably connected to the electronic device, for performing power delivery to the electronic device through a cable when being connected to the electronic device,
wherein the electronic device includes:
a first detecting circuit for performing a detection relating to power supply amount to output a first detection signal; and
a control signal terminal for transmitting the first detection signal to the power supply device when being connected to the power supply device, and
wherein:
the power supply device includes:
a power supply circuit an output of which is variable; and
a control circuit for performing an output control of the power supply device based on the first detection signal,
and wherein:
the first detection signal is an analog signal, and the first detecting circuit changes the first detection signal from a reference value by a predetermined amount according to a detected value relating to the power supply amount, and
the control circuit performs a control operation so as to increase the power supply output when the first detection signal is the reference value, and reduce the power supply output according to the changed amount when the detection signal is changed from the reference value by the predetermined amount.

18. The electronic system according to claim 17, wherein the detection relating to the power supply amount is a detection of power supply voltage and/or power supply current.

19. The electronic system according to claim 17, wherein:
the power supply device includes a second detecting circuit for detecting the output voltage and/or the output current to output a second detection signal, and
the control circuit performs the output control based on the second detection signal when the first detection signal is not inputted.

20. The electronic system according to claim 19, wherein:
the control circuit performs a control operation so as to increase the power supply output when the first detection signal and second detection signal are the reference value, and reduce the power supply output according to the changed amount when the first detection signal or the second detection signal is changed from the reference value by the predetermined amount,
the first detecting circuit or the second detecting circuit changes the first detection signal or the second detection signal from the reference value when the detected voltage exceeds each of setting voltages, and
the setting voltage of the second detecting circuit is larger than the setting voltage of the first detecting circuit.

21. The electronic system according to claim 19, wherein:
the control circuit performs a control operation so as to increase the power supply output when the first detection signal and second detection signal are the reference value, and reduce the power supply output according to the changed amount when the first detection signal or the second detection signal is changed from the reference value by the predetermined amount,
the first detecting circuit or the second detecting circuit change the first detection signal or the second detection signal from the reference value when the detected current exceeds each of setting currents, and
the setting current of the second detecting circuit is larger than the setting current of the first detecting circuit.

22. The electronic system according to claim 20, wherein:
the power supply device includes an adder circuit for adding the first detection signal and the second detection signal, and
the output control is performed by transmitting an output of the adder circuit to the control circuit.

23. The electronic system according to claim 17, wherein:
the electronic device further includes:
a third detecting circuit for performing a detection relating to the power supply amount; and
a first switching circuit for selectively switching an output of the first detecting circuit or the third detecting circuit to output it on a side of the power supply device, and
the power supply device further includes:
a fourth detecting circuit for performing a detection relating to the power supply amount to output a detection signal;
a second switching circuit for selectively switching a detection signal of the electronic device or the detection signal of the fourth detecting circuit to output the detection signal to the control circuit; and
a signal detecting circuit for detecting presence or absence of the detection signal from the electronic device to perform the switching of the second switching circuit,
and wherein:
the first detecting circuit, the third detecting circuit or the fourth detecting circuit change an output value from the reference value when the detected value exceeds each of setting values, and
the setting value of the first detection circuit is larger than the setting value of the fourth detecting circuit, and the setting value of the fourth detecting circuit is larger than the setting value of the third detecting circuit.

24. The electronic system according to claim 23, wherein:
the first switching circuit switches a connection on a side of the third detecting circuit when there is no output from the third detecting circuit, and switches a connection on a side of the first detecting circuit after a predetermined delay time passes when the output of the third detecting circuit is generated, and
the second switching circuit switches a connection on a side of the detection signal of the electronic device when the signal detection circuit detects presence of the detection signal, and switches a connection on a side of the fourth detecting circuit when the signal detecting circuit detects absence of the detection signal.

25. An electronic system, comprising:
an electronic device; and
a power supply device to be detachably connected to the electronic device, for performing power delivery to the electronic device through a cable when being connected to the electronic device,
wherein the electronic device includes:
a plurality of voltage detecting circuits each detecting an input power supply voltage, for respectively outputting voltage detection signals based on a plurality of setting voltages, each value of which differs each other; and
a third switching circuit for selectively switching a voltage detection signal of any of the plurality of voltage detecting circuits to output the voltage detection signal to the power supply device, and
wherein the power supply device includes:
a control circuit for performing an output control of the power delivery;
a current detecting circuit for detecting an output current to be able to output a current detection signal based on a plurality of setting currents, each value of which differs each other; and
a setting switching unit for switching the setting current of the current detecting circuit based on the output voltage,
and wherein the output control of the control circuit is performed based on the detection signal inputted from the electronic device and the detection signal of the current detecting circuit.

26. An electronic system, comprising:
an electronic device; and
a power supply device to be detachably connected to the electronic device, for performing power delivery to the electronic device through a cable when being connected to the electronic device,
wherein the electronic device includes:
a switching circuit series-connected on a power delivery line and capable of cutting off a power supply input;
a first voltage detecting circuit for detecting a power supply voltage at a node point on an internal circuit side by the switching circuit;
a second voltage detecting circuit for detecting the power supply voltage by the switching circuit on a power supply input terminal side; and
a signal switching circuit for switching the detection signal of the first voltage detecting circuit or the detection signal of the second voltage detecting circuit to a side of the power supply device,
and wherein the power supply device performs a power supply output control based on the detection signal.

27. The electronic system according to claim 26, wherein the signal switching circuit switches to a side of the first voltage detecting circuit when the switching circuit is on, and switches to a side of the second voltage detecting circuit when the switching circuit is off.

28. The electronic system according to claim 26, wherein:
the power supply device includes a control circuit for performing the power supply output control based on a detection signal transmitted from the electronic device, and
the control circuit controls to reduce the power supply voltage when the detection signal of the second voltage detecting circuit is inputted in comparison with the power supply voltage when the detection signal of the first voltage detecting circuit is inputted.

29. An electronic device, which operates by receiving power delivery from an external power supply device, comprising:
a detecting circuit for performing a detection relating to power supply amount to output a detection signal; and
a connector including a power supply input terminal for inputting power supply voltage and a control signal terminal for outputting the detection signal to the power supply device.

30. A power supply device, which performs power delivery through a cable when connecting to an external electronic device, comprising:
a power supply circuit an output of which is variable;
a control circuit for performing an output control of the power supply circuit; and
a connector including a power supply output terminal for performing power supply output from the power supply circuit and a control signal terminal for inputting an output control signal from an outside,
wherein the control circuit is configured to be able to perform an output control of the power supply circuit based on a signal of the control signal terminal.
